(19) United States
(12) Patent Application Publication
(10) Pub. No.: US 2016/0266428 A1
(43) Pub. Date: Sep. 15, 2016

(54) Illumination Device, Dedicated Eyeglasses Thereof, Analyzer Thereof and an Illumination System

(71) Applicant: BOE TECHNOLOGY GROUP CO., LTD., Beijing (CN)

(72) Inventors: Wenbo Li, Beijing (CN); Yanbing Wu, Beijing (CN)

(73) Assignee: BOE TECHNOLOGY GROUP CO., LTD., Beijing (CN)

(21) Appl. No.: 14/648,128

(22) PCT Filed: Sep. 22, 2014
(86) PCT No.: PCT/CN2014/087024

§ 371 Date: May 28, 2015

(30) Foreign Application Priority Data
Jun. 19, 2014 (CN) 201410277632.2

(51) Int. Cl. G02F 1/13363; G02F 1/1333; G02C 7/12; G02F 1/1335

(52) U.S. Cl. CPC G02F 1/13363; G02F 1/133528; G02F 1/133514; G02F 1/133512; G02F 1/133555; G02F 1/133308; G02C 7/12; G02F 2001/133638; G02F 2413/01; G02F 2413/05; G02F 2413/08

(57) ABSTRACT

An illumination device, dedicated eyeglasses thereof, analyzer thereof and an illumination system are provided. The illumination device includes a support member and a liquid crystal display panel mounted on the support member, and the liquid crystal display panel is provided with a first polarization sheet only at a light incident side. The liquid crystal display panel in the illumination device emits white light for the information contained therein cannot be observed by naked eye, and hence can be used as an illumination lamp; when the illumination device is viewed through the dedicated eyeglasses or the analyzer, the secret information displayed on the liquid crystal display panel can be observed.

### TECHNICAL FILED

At least one embodiment of the present invention relates to an illumination device, dedicated eyeglasses thereof, analyzer thereof, and an illumination system.

### BACKGROUND

Illumination devices, as daily consuming products, have been greatly varied as the development of the economic society and the emergence of the new light source such as fluorescent lamp, energy saving lamp, LED lamp, and so on. The variety and the multiple choices of the light sources also make the illumination lamp industry to be renewed. It is necessary to decorate the places such as city plazas, traffic roads, new built communities, house decoration, super markets, office buildings, and so on by using the illumination products, and hence occurs new requirement thereto.

### SUMMARY

At least one embodiment of the present invention provides an illumination device, dedicated eyeglasses thereof, analyzer thereof, and an illumination system, by which the secret information displayed on the crystal liquid panel can not be observed by naked eyes so that the illumination device is used as an illumination lamp, but can be observed by means of the dedicated eyeglasses or the analyzer.

At least one embodiment of the present invention provides an illumination device comprising a support member and a liquid crystal display panel mounted on the support member, wherein the liquid crystal display panel is provided with a first polarization sheet only at a light incident side.

At least one embodiment of the present invention further provides a pair of dedicated eyeglasses configured for the above illumination device provided by the embodiment of the present invention, the pair of dedicated eyeglasses include lenses each having a second polarization sheet.

At least one embodiment of the present invention further provides an analyzer configured for the above illumination device provided by the embodiment of the present invention, the analyzer includes a second polarization sheet.

At least one embodiment of the present invention further provides an illumination system comprising the above illumination device provided by the embodiment of the present invention and the above dedicated eyeglasses provided by the embodiment of the present invention; or comprising the above illumination device provided by the embodiment of the present invention and the above analyzer provided by the embodiment of the present invention which is provided at a certain distance from the above illumination device provided by the embodiment of the present invention.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a schematic diagram illustrating a structure of an illumination device provided by an embodiment of the present invention;

FIG. 2a and FIG. 2b are schematic diagrams illustrating a structure of a liquid crystal display panel in the illumination device provided by a first embodiment of the present invention, respectively;

FIG. 3a to FIG. 3c are schematic diagrams illustrating a principle of the first embodiment of the present invention;

FIG. 4a to FIG. 4d are schematic diagrams illustrating a structure of a liquid crystal display panel in an illumination device provided by a second embodiment of the present invention, respectively;

FIG. 5a and FIG. 5b are schematic diagrams illustrating a principle of the second embodiment of the present invention.

### DETAILED DESCRIPTION OF THE PREFERRED EMBODIMENTS

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

The inventor of the present invention noticed that the current illumination products only have ordinary illuminating function but do not have other distinguishable, special display functions.

At least one embodiment of the present invention provides an illumination device comprising a support member and a liquid crystal display panel mounted on the support member, wherein the liquid crystal display panel includes a first polarization sheet only at a light incident side.

For example, in the above illumination device, a quarter-wave plate is provided at a light emergent side of the liquid crystal display panel, the quarter-wave plate has a fast axis forming a predetermined angle with a polarization axis of the first polarization sheet, and the predetermined angle is greater than or equal to 0 degree and smaller than or equal to 90 degree. For example, the predetermined angle is 45 degree.

For example, in the above illumination device, the liquid crystal display panel includes an array substrate and a counter substrate opposite to each other, and a liquid crystal layer provided between the array substrate and the counter substrate. A black matrix layer and a color filter layer are provided at a side of the counter substrate facing the array substrate or at a side of the array substrate facing the counter substrate; alternatively, only the black matrix layer is provided at the side of the counter substrate facing the array substrate or at the side of the array substrate facing the counter substrate.

For example, the above illumination device may further include a transflective layer provided on a light emergent side of the liquid crystal display panel. For example, in the above illumination device, the transflective layer may be provided on a transparent substrate at a side of the counter substrate facing away from the array substrate; alternatively, the transflective layer may be provided at a surface of the counter substrate facing the array substrate and/or a surface of the counter substrate facing away from the array substrate. For example, the quarter-wave plate may be provided at the light emergent side of the liquid crystal display panel, and the transflective layer may be provided on the transparent substrate between the counter substrate and the quarter-wave plate.

At least one embodiment of the present invention further provides a pair of dedicated eyeglasses configured for the above illumination device, the pair of dedicated eyeglasses includes lenses each having a second polarization sheet. For example, the lense may further include a quarter-wave plate, and the quarter-wave plate and the second polarization sheet are sequentially arranged in a direction from a light incident side towards a light emergent side of the lense. The quarter-wave plate has a fast axis forming an angle with a polarization axis of the second polarization sheet, and the angle is equal with the predetermined angle. Alternatively, the angel formed between the fast axis of the quarter-wave plate and the polarization axis of the second polarization sheet plus the predetermined angle equals 90 degree.

At least one embodiment of the present invention further provides an analyzer including a second polarization sheet configured for the above illumination device. For example, the analyzer may further include a quarter-wave plate, and the quarter-wave plate and the second polarization sheet are sequentially arranged in a direction from the light incident side towards the light emergent side. The quarter-wave plate has a fast axis forming an angle with a polarization axis of the second polarization sheet, and the angle is equal with the predetermined angel. Alternatively, the angle formed between the fast axis of the quarter-wave plate and the polarization axis of the second polarization sheet plus the predetermined angle equals 90 degree.

At least one embodiment of the present invention further provides an illumination system including any one of the above described illumination device and any one of the above described dedicated eyeglasses; alternatively, the illumination system includes any one of the above described illumination device and any one of the above described analyzer which is provided at a certain distance from the illumination device. For example, in the above illumination system, upon the liquid crystal display panel being provided with the quarter-wave plate at the light emergent side, the pair of dedicated eyeglasses includes the lenses each having the quarter-wave plate, or the analyzer includes the quarter-wave plate.

Hereinafter, the particular embodiment of the illumination device, dedicated eyeglasses thereof, analyzer thereof, and the illumination system provided by the embodiments of the present invention will be described in detail with reference to the attached figures.

It is noted that the shape and size of the areas in the attached figures are not intended to be drawn in the real scale of the illumination device but only to schematically illustrate the content of the present invention.

### The First Embodiment

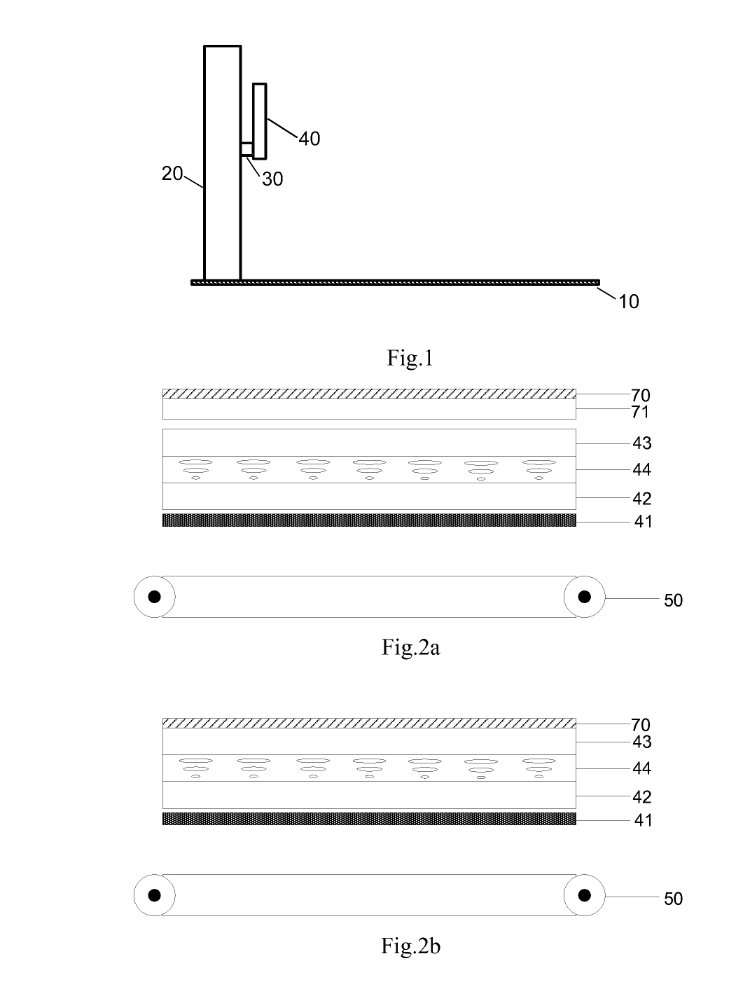

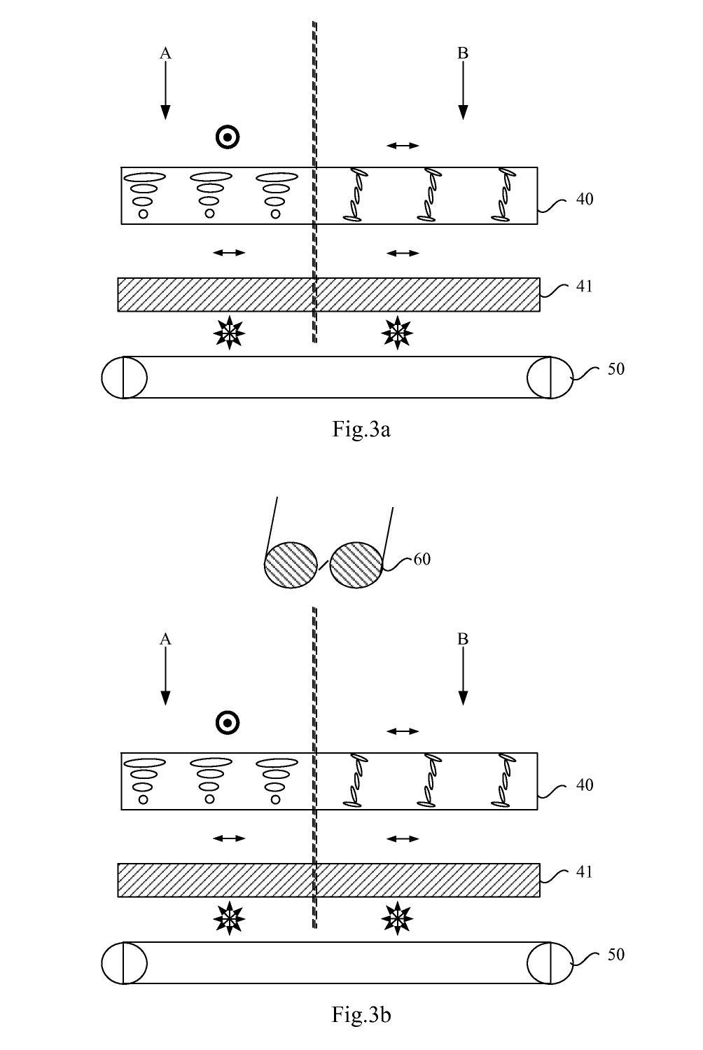

As shown in FIG. 1, an illumination device provided in the first embodiment includes a support member 30 and a liquid crystal display panel 40 mounted on the support member 30. As shown in FIG. 2a and FIG. 2b, the liquid crystal display panel 40 is provided with a first polarization sheet 41 only at a light incident side, that is, the first polarization sheet 41 is provided at a light emitting side of a backlight module 50.

In the present embodiment, the illumination device is described as a wall lamp by way of example. In particular implementation, as shown in FIG. 1, the support member 30 in the illumination device can be used to fix the liquid crystal display panel 40 on a wall 20 perpendicular to the ground 10. Of course, the illumination device provided by the present embodiment may also be used as a ceiling lamp, without limiting the present invention thereto.

Hereinafter, the principle of the above illumination device provided by the first embodiment will be described.

In order to facilitate the illustration of the benefit effect of the illumination device, a pair of dedicated eyeglasses configured for the above illumination device provided by the first embodiment is introduced, and the pair of dedicated eyeglasses includes lenses each having a second polarization sheet; or an analyzer configured for the above illumination device provided by the first embodiment of the present invention is introduced, and the analyzer includes a second polarization sheet. In particular implementation, the pair of dedicated eyeglasses may be moved with the wearer, while the analyzer generally is provided at a fixed position with a certain distance from the illumination device. Hereinafter the pair of dedicated eyeglasses or the analyzer will not be described individually.

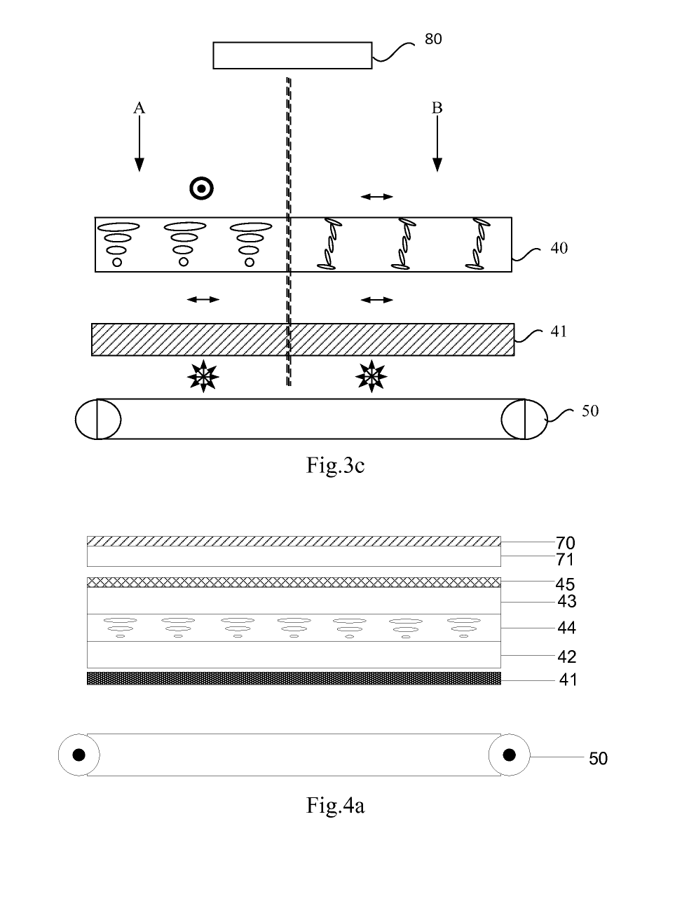

In the illumination device provided by the first embodiment of the present invention, as shown in FIG. 3a, area A and area B as illustrated render a bright state and a dark state, respectively, and the liquid crystal display panel 40 is provided with only the first polarization sheet 41 through which light is polarized into linearly polarized light emergent upon transmitting through the liquid crystal display panel 40. As the light is not filtered by a second polarization sheet, information contained therein can not be observed, so the illumination device emits white light and hence can be used as an illumination lamp.

As shown in FIG. 3b and FIG. 3c, when viewing the liquid crystal display panel 40 through a pair of dedicated eyeglasses 60 or an analyzer 80, secret information displayed by the liquid crystal display panel 40 can be observed as the second polarization sheet in the pair of dedicated eyeglasses 60 or the analyzer 80 functions to filter the light.

In particular implementation, the above illumination device provided by the first embodiment of the present invention can be used in a meeting room or in an exhibition hall. For example, a row of the above illumination devices can be provided in the exhibition hall as wall lamps so that they only function to illuminate for an ordinary visitor but a staff may observe notification, client information and the like on the illumination device by wearing a pair of special, dedicated eyeglasses having the second polarization sheet or by using a fixedly provided analyzer.

Since the liquid crystal display panel 40 in the above illumination device is used as an illumination lamp, there is no strict requirement on the color gamut of the panel. In one example, when the secret information to be displayed is not relevant to the color, that is, when the content to be displayed is only black-white picture information having gray scale, the color filter layer in the liquid crystal display panel 40 can be omitted. Thus, on one hand the manufacturing process of the liquid crystal display panel 40 can be simplified and on the other hand the illumination brightness of the liquid crystal display panel 40 as an illumination lamp can be increased.

In one example, as shown in FIG. 2a and FIG. 2b, the liquid crystal display panel 40 may include an array substrate 42 and a counter substrate 43 opposite to each other, and a liquid crystal layer 44 provided between the counter substrate 43 and the array substrate 42. A black matrix layer and a color filter layer are provided at a side of the counter substrate 43 facing the array substrate 42 or at a side of the array substrate 42 facing the counter substrate 43. Alternatively, the color filter layer can be omitted, that is, only the black matrix layer is provided at a side of the counter substrate 43 facing the array substrate 42 or at a side of the array substrate 42 facing the counter substrate 43.

When not in use, the illumination device provided by the embodiment of the present invention generally renders black color. However, in order to improve the practicability and aesthetics of the illumination device, in one example, a transflective layer can be provided at the light emergent side of the liquid crystal display panel 40 so that the illumination device can be used as a mirror by reflecting the ambient light when not in use.

For example, provision of the transflective layer at the light emergent side of the liquid crystal display panel 40 can be achieved by employing a metalized film or a bright enhancement film (DEBEF).

For example, as shown in FIG. 2a, the transflective layer 70 may be provided on a transparent substrate 71 at a side of the counter substrate 43 facing away from the array substrate 42, or the transflective layer 70 may also be directly provided on a surface of the counter substrate 43 facing the array substrate 42 and/or facing away from the array substrate 42. As shown in FIG. 2b, by providing the transflective layer 70 on the surface of the counter substrate 43 facing away from the array substrate 42, the structure of the device can be simplified as compared with additionally providing a transparent substrate 71 configured to carry the transflective layer 70 as shown in FIG. 2a.

Based on the same invention idea, the first embodiment of the present invention further provides an illumination system including the above illumination device as provided by the first embodiment of the present invention and the pair of dedicated eyeglasses configured for the illumination device; or the illumination system includes the above illumination device as provided by the first embodiment of the present invention and the analyzer configured for the illumination device, which analyzer is provided at a certain distance from the illumination device. The implementation of the illumination system may refer to the embodiment described with reference to the above illumination device and the dedicated eyeglasses or analyzer thereof, and will not be repeatedly described herein.

In the above illumination device, dedicated eyeglasses thereof, analyzer thereof and the illumination system provided by the embodiment of the present invention, the liquid crystal display panel is used as a lamp and is provided with the first polarization sheet only on the light incident side, that is, the light emergent side of the liquid crystal display panel is not provided with the second polarization sheet. In this way, when the liquid crystal display panel is in operation, the light from the backlight module is converted into linearly polarized light upon passing through the first polarization sheet; since the linearly polarized light is not filtered by a second polarization sheet when transmitting through the liquid crystal display panel, the information contained therein cannot be observed by naked eyes, so the illumination device emits white light and hence can be used as an illumination lamp; by wearing the pair of dedicated eyeglasses including the lenses each having the second polarization sheet, or by means of the analyzer having the second polarization sheet provided at a certain distance from the illumination device, the secret information displayed by the liquid crystal display panel can be observed owing to the filter action of the second polarization sheet.

### The Second Embodiment

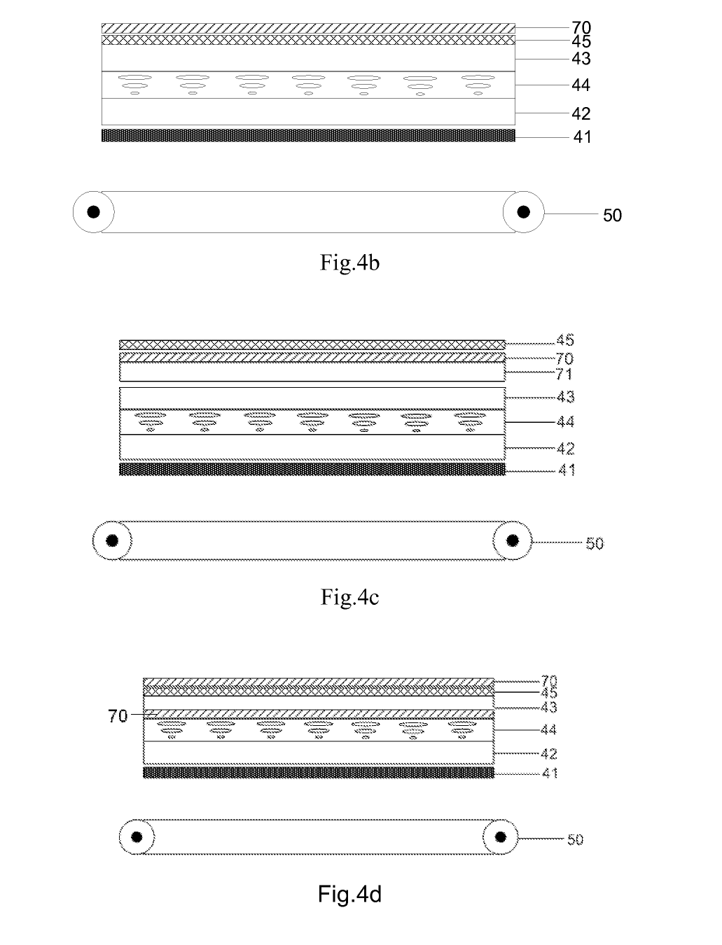

In practical, the above illumination device provided by the first embodiment of the present invention involves problem that light leakage may be occurred in the pair of dedicated eyeglasses due to incorrect viewing angle (for example, the user tilts his head and so on), or light leakage may be occurred for that the analyzer and the illumination device are not fixed at proper position. In order to improve the display quality for displaying secret information on the liquid crystal display panel when viewing the same by wearing the pair of dedicated eyeglasses or by utilizing the analyzer, as shown in FIG. 1, the second embodiment of the present invention provides an illumination device including a support member 30 and a liquid crystal display panel 40 mounted on the support member 30. As shown in FIG. 4a and FIG. 4b, the liquid crystal display panel 40 is provided with a first polarization sheet 41 only at a light incident side, that is, the first polarization sheet is provided at a light emitting side of a backlight module 50, and a quarter-wave plate 45 is provided at a light emergent side. The quarter-wave plate 45 has a fast axis forming a predetermined angle with a polarization axis of the first polarization sheet 41, and the predetermined angle is greater than or equal to 0 degree and smaller than or equal to 90 degree.

In the present embodiment, the illumination device is described as a wall lamp by way of example. In particular implementation, as shown in FIG. 1, the support member 30 in the illumination device can be used to fix the liquid crystal display panel 40 on a wall 20 perpendicular to the ground 10. Of course, the illumination device provided by the present embodiment may also be used as a ceiling lamp without limiting the present invention thereto.

Hereinafter, the principle of the above transparent display device provided by the second embodiment of the present invention will be described.

In order to facilitate the illustration of the benefit effect of the illumination device, a pair of dedicated eyeglasses configured for the above illumination device provided by the second embodiment of the present invention is introduced herein, the pair of dedicated eyeglasses includes lenses each having a quarter-wave plate and a second polarization sheet which are sequentially arranged in a direction from the light incident side towards the light emergent side of the lens, and an angle formed between the fast axis of the quarter-wave plate and the polarization axis of the second polarization sheet is equal with the predetermined angle, or the angle plus the predetermined angle equals 90 degree. Alternatively, an analyzer configured for the above illumination device provided by the second embodiment of the present invention is introduced, the analyzer includes a quarter-waver plate and a second polarization sheet which are sequentially arranged in a direction from the light incident side towards the light emergent side, and an angle formed between the fast axis of the quarter-wave plate and the polarization axis of the second polarization sheet is equal with the predetermined angle, or the angle plus the predetermined angle equals 90 degree. In practical implementation, the pair of dedicated eyeglasses can be moved with the wearer, while the analyzer can be provided at a fixed position with a certain distance from the illumination device. Hereinafter the dedicated eyeglasses or the analyzer will not be described individually.

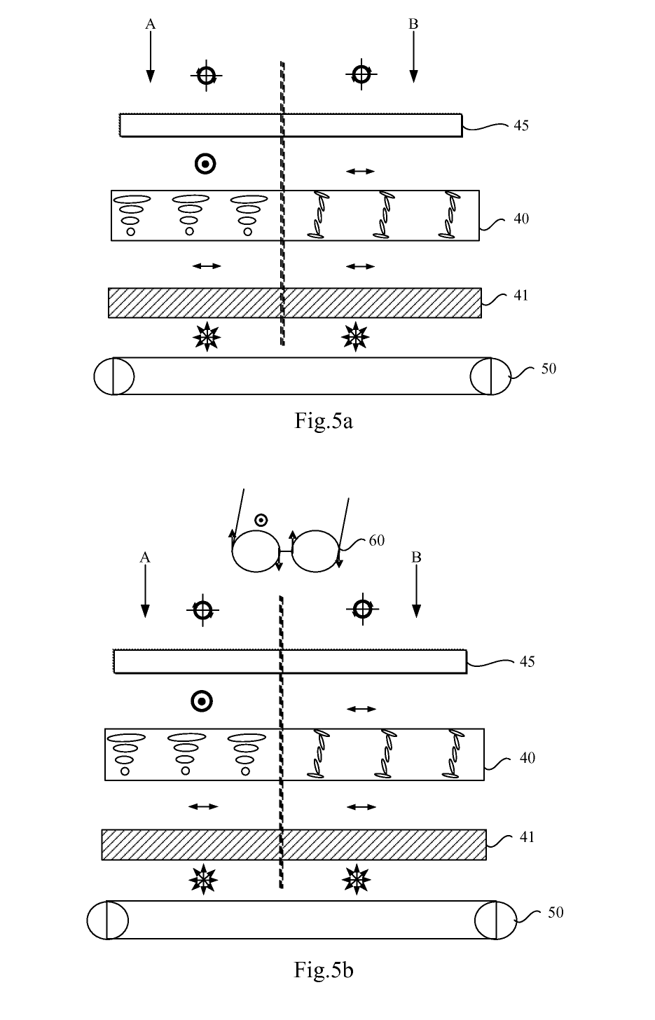

In the illumination device provided by the second embodiment of the present invention, as shown in FIG. 5a, area A and area B render a bright state and a dark state, respectively, the liquid crystal display panel 40 is provided with only the first polarization sheet 41, and light is polarized into linearly polarized light upon passing through the first polarization sheet 41, which linearly polarized light is transmitting through the liquid crystal display panel 40 and then incident on the quarter-wave plate. Since the quarter-wave plate 45 can convert the linearly polarized light whose polarization direction forms an angle of 45 degree with a fast axis or slow axis of the quarter-wave plate into circularly polarized light, and convert the linearly polarized light whose polarization direction forms an acute angle other than 45 degree with the fast axis or the slow axis of the quarter-wave plate into elliptically polarized light, the information contained in the liquid crystal display panel 40 that is subject to modulation by the quarter-wave plate 45 can not be observed by naked eyes, so the liquid crystal display panel 40 emits white light and hence can be used as an illumination lamp.

In the case where the above predetermined angle is set as 90 degree or 0 degree, the linearly polarized light transmitted through the first polarization sheet 41 rotates the polarization direction thereof by 90 degree or 0 degree to form an included angle of 0 degree or 90 degree with the fast axis of the quarter-wave plate 45 when transmitting through the liquid crystal display panel 40, so the light transmitted through the quarter-wave plate 45 is still in a form of linearly polarized light; at this time, as shown in FIG. 5b, the fast axis of the quarter-wave plate in the pair of dedicated eyeglasses 60 or in the analyzer (not illustrated in the figures) forms an included angle of 0 degree or 90 degree with the polarization axis of the second polarization sheet; in this way, when the polarization axis of the second polarization sheet is perpendicular to or parallel with the polarization axis of the first polarization sheet 41, the secret information displayed by the liquid crystal display panel 40 can be observed by means of the pair of dedicated eyeglasses 60 or the analyzer.

In the case where the above predetermined angle is set as 45 degree, the linearly polarized light transmitted through the first polarization sheet 41 rotates the polarization direction thereof by 90 degree or 0 degree to form an included angle of 45 degree with the fast axis of the quarter-wave plate 45 when transmitting through the liquid crystal display panel 40, so the light transmitted through the quarter-wave plate 45 becomes circularly polarized light; the fast axis of the quarter-wave plate in the pair of dedicated eyeglasses 60 or in the analyzer forms an included angle of 45 degree with the polarization axis of the second polarization sheet; in this way, the secret information displayed on the liquid crystal display panel 40 can always be observed by means of the pair of dedicated eyeglasses 60 or the analyzer given any value of the included angle formed between the polarization axis of the second polarization sheet in the pair of dedicated eyeglasses or in the analyzer and the polarization axis of the first polarization sheet 41 in the liquid crystal display panel 40.

In the case where the above predetermined angle is set as other acute angle, the linearly polarized light transmitted through the first polarization sheet 41 rotates the polarization direction thereof by 90 degree or 0 degree to form an acute angle other than 45 degree with the fast axis of the quarter-wave plate 45 when transmitting through the liquid crystal display panel 40, so the light transmitted through the quarter-wave plate 45 becomes elliptically polarized light. In this way, if an included angle between the fast axis of the quarter-wave plate in the pair of dedicated eyeglasses 60 or in the analyzer and the polarization axis of the second polarization sheet is equal with the above predetermined angle, the secret information displayed on the liquid crystal display panel 40 can be observed by means of the pair of dedicated eyeglasses or the analyzer when the fast axes of two quarter-wave plates are perpendicular to each other; if the angle formed between the fast axis of the quarter-wave plate in the pair of dedicated eyeglasses 60 or in the analyzer and the second polarization sheet plus the predetermined angle equals 90 degree, the secret information displayed on the liquid crystal display panel 40 can be observed by means of the pair of dedicated eyeglasses 60 or the analyzer when the fast axes of the two quarter-wave plates are parallel with each other.

Therefore, only when the illumination device is viewed by means of the pair of dedicated eyeglasses 60 or the analyzer which is provided with the quarter-wave plate and the second polarization sheet, can the secret content displayed on the liquid crystal display panel 40 be observed. Furthermore, by providing the quarter-wave plate in both the liquid crystal display panel 40 and the pair of dedicated eyeglasses 60 or the analyzer, the matching effect of the illumination device and the pair of dedicated eyeglasses 60 or the analyzer can be improved, which makes it possible to avoid occurrence of light leakage in the pair of dedicated eyeglasses 60 or the analyzer due to incorrect viewing angle of the observer, so as to improve the display quality for displaying the secret content of the liquid crystal display panel 40 when viewing the same by wearing the pair of dedicated eyeglasses or by utilizing the analyzer.

In practical implementation, the above illumination device provided by the second embodiment of the present invention can be used in a meeting room or in an exhibition hall. For example, a row of the above illumination devices can be provided in the exhibition hall so that they only function to illuminate for an ordinary visitor but a staff may observe notification, client information and so on from the illumination device by wearing a pair of special, dedicated eyeglasses having the quarter-wave plate and the second polarization sheet or by using a fixedly provided analyzer.

Since the liquid crystal display panel 40 in the above illumination device is used as an illumination lamp, there is no strict requirement on the color gamut of the panel. In one example, when the secret information to be displayed is not relevant to the color, that is, when the content to be displayed is only black-white picture information having gray scale, the color filter layer in the liquid crystal display panel 40 can be omitted. Thus, on one hand the manufacturing process of the liquid crystal display panel 40 can be simplified and on the other hand the illumination brightness of the liquid crystal display panel 40 as an illumination lamp can be increased.

For example, as shown in FIG. 4a and FIG. 4b, the liquid crystal display panel 40 may include an array substrate 42 and a counter substrate 43 opposite to each other, and a liquid crystal layer 44 provided between the counter substrate 43 and the array substrate 42. A black matrix layer and a color filter layer are provided at a side of the counter substrate 43 facing the array substrate 42 or at a side of the array substrate 42 facing the counter substrate 43. Alternatively, the color filter layer can be omitted, that is, only the black matrix layer is provided at a side of the counter substrate 43 facing the array substrate 42 or at a side of the array substrate 42 facing the counter substrate 43.

When not in use, the illumination device provided by the embodiment of the present invention generally renders black color. However, in order to improve the practicability and aesthetics of the illumination device, in one example, a transflective layer 70 can be provided at the light emergent side of the liquid crystal display panel 40 so that the illumination device can be used as a mirror by reflecting the ambient light when not in use.

For example, provision of the transflective layer 70 on the light emergent side of the liquid crystal display panel 40 can be achieved by employing a metalized film or a bright enhancement film (DEBEF).

For example, as shown in FIG. 4a, the transflective layer 70 may be provided on a transparent substrate 71 at a side of the counter substrate 43 facing away from the array substrate 42. In the present embodiment, since a quarter-wave plate 45 is provided at the light emergent side of the liquid crystal display panel, provision of the transflective layer 70 on the transparent substrate 71 can be achieved by providing the transflective layer 70 on a transparent substrate 71 at a side of the counter substrate 43 facing away from the array substrate 42 and at a side of the quarter-wave plate 45 facing away from the array substrate 42 as shown in FIG. 4a, or by providing the transflective layer 70 on a transparent substrate 71 provided between the counter substrate 43 and the quarter-wave plate 45 as shown in FIG. 4c, in different examples. The transflective layer 70 may also be provided directly on a surface of the counter substrate 43 facing the array substrate 42 and/or a surface of the counter substrate 43 facing away from the array substrate 42, without using the transparent substrate. In one example, as shown in FIG. 4b, the transflective layer 70 may be provided on the surface of the counter substrate 43 facing away from the array substrate 42, and a quarter-wave plate 45 is adhered onto the transflective layer 70. In one example, as shown in FIG. 4d, both the surfaces of the counter substrate 43 facing the array substrate 42 and facing away from the array substrate 42 may be provided with the transflective layers 70, and a quarter-wave plate 45 is adhered onto the transflective layer 70 at the side of the counter substrate 43 facing away form the array substrate 42. Compared with the solution as shown in FIG. 4a and FIG. 4c in which the transparent substrate 71 is additionally provided for carrying the transflective layer 70, the solution illustrated in FIG. 4b and FIG. 4d in which the transparent substrate 71 is omitted can simplify the structure of the device.

Based on the same invention idea, the second embodiment of the present invention further provides an illumination system including the above illumination device as provided by the second embodiment of the present invention and the pair of dedicated eyeglasses configured for the illumination device; or the illumination system includes the above illumination device as provided by the second embodiment of the present invention and the analyzer configured for the illumination device, which analyzer is provided at a certain distance from the illumination device. The implementation of the illumination system may refer to the embodiment described with reference to the above illumination device and the pair of dedicated eyeglasses or analyzer thereof, and will not be repeatedly described herein.

Obviously, an ordinary person in the art can make various variations and modifications to the present invention without departure from the spirit and the scope of the present invention, and such variations and modifications shall fall in the scope of the present invention.

The present invention claims priority of Chinese patent application No. 201410277632.2 filed on Jun. 19, 2014 which is incorporated herein by reference in its entirely.

1. An illumination device, comprising: a support member and a liquid crystal display panel mounted on the support member, wherein,
the liquid crystal display panel is provided with a first polarization sheet only at a light incident side.

2. The illumination device of claim 1, wherein,
the liquid crystal display panel is provided with a quarter-wave plate at a light emergent side, the quarter-wave plate has a fast axis forming a predetermined angle with a polarization axis of the first polarization sheet, and the predetermined angle is greater than or equal to 0 degree and is smaller than or equal to 90 degree.

3. The illumination device of claim 1, wherein the liquid crystal display panel comprises: an array substrate and a counter substrate opposite to each other; and a liquid crystal layer provided between the counter substrate and the array substrate; wherein,
a black matrix layer and a color filter layer are provided at a side of the counter substrate facing the array substrate or at a side of the array substrate facing the counter substrate; or
only the black matrix layer is provided at the side of the counter substrate facing the array substrate or at the side of the array substrate facing the counter substrate.

4. The illumination device of claim 1, further comprising: a transflective layer provided at a light emergent side of the liquid crystal display panel.

5. The illumination device of claim 4, wherein the transflective layer is provided on a transparent substrate at a side of the counter substrate facing away from the array substrate; or
the transflective layer is provided on a surface of the counter substrate facing the array substrate and/or a surface of the counter substrate facing away from the array substrate.

6. The illumination device of claim 5, wherein upon the liquid crystal display panel being provided with the quarter-wave plate at the light emergent side and the transflective layer being provided on the transparent substrate,
the transflective layer is provided on the transparent substrate between the counter substrate and the quarter-wave plate; or
the transflective layer is provided on the transparent substrate at the side of the counter substrate facing away from the array substrate and at a side of the quarter-wave plate facing away from the array substrate.

7. The illumination device of claim 2, wherein the liquid crystal display panel is provided with the quarter-wave plate at the light emergent side, and the predetermined angle is 45 degree.

8. A pair of dedicated eyeglasses configured for the illumination device of claim 1, comprising lenses each having a second polarization sheet.

9. The pair of dedicated eyeglasses of claim 8, wherein
each of the lenses further comprises a quarter-wave plate, the quarter-wave plate and the second polarization sheet are sequentially arranged in a direction from a light incident side towards a light emergent side of the lense;
an angle formed between a fast axis of the quarter-wave plate and a polarization axis of the second polarization sheet is equal with a predetermined angle formed between a fast axis of the quarter-wave plate and a polarization axis of the first polarization sheet and the predetermined angle is greater than or equal to 0 degree and is smaller than or equal to 90 degree; or, the predetermined angle plus the angle formed between the fast axis of the quarter-wave plate and the polarization axis of the second polarization sheet equals 90 degree.

10. An analyzer configured for the illumination device of claim 1, comprising a second polarization sheet.

11. The analyzer of claim 10, further comprising a quarter-wave plate, wherein
the quarter-wave plate and the second polarization sheet are sequentially arranged in a direction from a light incident side towards a light emergent side;
an angle formed between a fast axis of the quarter-wave plate and a polarization axis of the second polarization sheet is equal with a predetermined angle formed between a fast axis of the quarter-wave plate and a polarization axis of the first polarization sheet and the predetermined angle is greater than or equal to 0 degree and is smaller than or equal to 90 degree; or, the predetermined angle plus the angle formed between the fast axis of the quarter-wave plate and the polarization axis of the second polarization sheet equals 90 degree.

12. An illumination system, comprising:
an illumination device comprising a support member and a liquid crystal display panel mounted on the support member, wherein, the liquid crystal display panel is provided with a first polarization sheet only at light incident side; and
a pair of dedicated eyeglasses comprising lenses each having a second polarization sheet, or, an analyzer comprising a second polarization sheet, wherein the analyzer is provided at a certain distance from the illumination device.

13. The illumination system of claim 12, wherein upon the liquid crystal display panel being provided with a quarter-wave plate at a light emergent side, the pair of dedicated eyeglasses comprises lenses each having the quarter-wave plate or the analyzer comprises the quarter-wave plate.

14. The illumination device of claim 2, wherein the liquid crystal display panel comprises: an array substrate and a counter substrate opposite to each other; and a liquid crystal layer provided between the counter substrate and the array substrate; wherein,
a black matrix layer and a color filter layer are provided at a side of the counter substrate facing the array substrate or at a side of the array substrate facing the counter substrate; or
only the black matrix layer is provided at the side of the counter substrate facing the array substrate or at the side of the array substrate facing the counter substrate.

15. The illumination device of claim 2, further comprising: a transflective layer provided at the light emergent side of the liquid crystal display panel.

16. The illumination device of claim 3, further comprising: a transflective layer provided at a light emergent side of the liquid crystal display panel.

17. The illumination device of claim 15, wherein the transflective layer is provided on a transparent substrate at a side of the counter substrate facing away from the array substrate; or
the transflective layer is provided on a surface of the counter substrate facing the array substrate and/or a surface of the counter substrate facing away from the array substrate.

18. The illumination device of claim 16, wherein the transflective layer is provided on a transparent substrate at a side of the counter substrate facing away from the array substrate; or
the transflective layer is provided on a surface of the counter substrate facing the array substrate and/or a surface of the counter substrate facing away from the array substrate.

19. The illumination device of claim 3, wherein the liquid crystal display panel is provided with the quarter-wave plate at a light emergent side, and a predetermined angle formed between a fast axis of the quarter-wave plate and a polarization axis of the first polarization sheet is 45 degree.

20. The illumination device of claim 4, wherein the liquid crystal display panel is provided with the quarter-wave plate at a light emergent side, and a predetermined angle formed between a fast axis of the quarter-wave plate and a polarization axis of the first polarization sheet is 45 degree.
